(19) United States
(12) Patent Application Publication
(10) Pub. No.: US 2008/0250054 A1
(43) Pub. Date: Oct. 9, 2008

(54) OBJECT BASED HEURISTICS DATABASE PLATFORM

(76) Inventor: Donald Bert Nickel, Dayton, OH (US)

Correspondence Address: MICHAEL RIES, 318 PARKER PLACE, OSWEGO, IL, 60543, US

(21) Appl. No.: 12/034,402

(22) Filed: Feb. 20, 2008

Related U.S. Application Data
(60) Provisional application No. 60/902,262, filed on Feb. 20, 2007.

(51) Int. Cl. G06F 17/30

(52) U.S. Cl. 707/102; 707/E17.055

(57) ABSTRACT

The present invention creates a secured and decoupled enterprise fixed asset management platform where the schema can be quickly adjusted to handle emergent types of data, where the client software does not need to be modified when the underlying system changes, and where the end-user can quickly find said data.

This application claims priority to U.S. Provisional Application 60/902,262 filed Feb. 20, 2007, the entire disclosure of which is incorporated by reference.

### TECHNICAL FIELD & BACKGROUND

The present invention generally relates to asset management platforms. More specifically, the present invention creates a secured and decoupled enterprise fixed asset management platform where the schema can be quickly adjusted to handle emergent types of data, where the client software does not need to be modified when the underlying system changes, and where the end-user can quickly find said data.

The present invention solves the need for a database system where the schema can be modified at run time to handle new types of data, and new structures quickly, and without modifying the user's experience. In certain environments, large amounts of disparate or anomalous data make using a standard database system inappropriate or difficult to use. There is a need for the platform to be decoupled yet secure. The present invention does this by using features such as extrapolative relationships, dynamic schema, and aliased and variant values, this system can adjust to new data types, and new schema elements quicker than current database systems, and can change them while the system is in use.

The present invention does this by using features such as the path-reduction queries and layered image maps, the end-user can get to their data quickly, and the end-user's interface can adjust to the new schema and functions. The present invention does this bye using features such as the JIT Collection Instance the system can handle large amounts of anomalous data. The present invention does this by using layered encryption and the separate core features allows the platform to become decoupled and still ensure security.

Existing databases systems require direct editing of the schema to deal with new data types or new data structures; ours allows new data structures and new data types to be added while the system is active. Current platforms require new client software to deal with back-office changes (such and new data structures); this system allows the client to use new functions and data structures without altering the client interface. Current platforms require either hard-coded queries, user-entered queries, or parameterized queries to locate specific data—ours uses path reduction coupled with the dynamic schema. Existing database systems require full enumeration of a table/view when instantiating a collection of objects based on that table/view; ours does not.

Improvements and new features of the present invention include the following:—Dynamic Schema with Path-Reduction Queries—A schema that can be adjusted on the fly, coupled with heuristics based queries allow for—Extrapolative relationships—Stems—Storing compiled code, source code, and its related data in the database and compiling as needed. This allows new data types and functionality to be added as new needs emerge. JIT Collections—Collections of objects where only one object is actually instantiated at any given time. This allows for large amounts of anomalous data to exist and be represented without taxing the hosting computer. Layered Encryption/Codepage/Letterbox—allows multiple encryption layers to be used at varying strengths to improve security, and make brute force attacks less feasible. Separate system core—allows the core of the system to be made completely unavailable and the underlying database inaccessible—even if the attacker had physical access to the core system at one time, while allowing any existing users with complete access. Any user that does not have the separate system core cannot even see these functions. Flashback—allows the data to be rolled back based on entry time or entry user.

The present invention is system that stores generic information about objects, their relationships, and their specifications in separate table sets, as well as information describing how the objects are classified and how the specifications should be presented. As the data is modified, new specifications are created for that object. When the data is initially presented to the user, the system retrieves the meta-data about the objects using the path-reduction queries. When a specific object is selected, the JIT Collection instantiates that object at that time. If additional functionality is needed to render the data, the stem loads or compiles the code needed—and loads the data into the new code. The data can be passed through the layered encryption before and after transporting to the end-user. Any administrative functions or functions modifying the classifications or specification metadata are called vicariously through the system core.

The present invention is generally for storing large amounts of disparate and anomalous data, and allowing the end-user to quickly access this data in an enterprise or decoupled environment in an easy and natural way. The immediate use for this invention is fixed asset management for enterprises.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a flow chart of a asset management platform, in accordance with one embodiment of the present invention;

FIG. 2 illustrates a flow chart of a asset management platform, in accordance with one embodiment of the present invention.

FIG. 3 illustrates a flow chart of a asset management platform, in accordance with one embodiment of the present invention;

FIGS. 4a and 4b illustrates a flow chart of a asset management platform, in accordance with one embodiment of the present invention;

FIG. 5 illustrates a flow chart of a asset management platform, in accordance with one embodiment of the present invention;

FIG. 6 illustrates a flow chart of a asset management platform, in accordance with one embodiment of the present invention;

FIG. 7 illustrates a flow chart of a asset management platform, in accordance with one embodiment of the present invention;

FIG. 8 illustrates a flow chart of a asset management platform, in accordance with one embodiment of the present invention;

FIG. 9 illustrates a flow chart of a asset management platform, in accordance with one embodiment of the present invention;

FIG. 10 illustrates a flow chart of a asset management platform, in accordance with one embodiment of the present invention;

FIG. 11 illustrates a flow chart of a asset management platform, in accordance with one embodiment of the present invention;

FIG. 12 illustrates a flow chart of a asset management platform, in accordance with one embodiment of the present invention;

FIG. 13 illustrates a flow chart of a asset management platform, in accordance with one embodiment of the present invention;

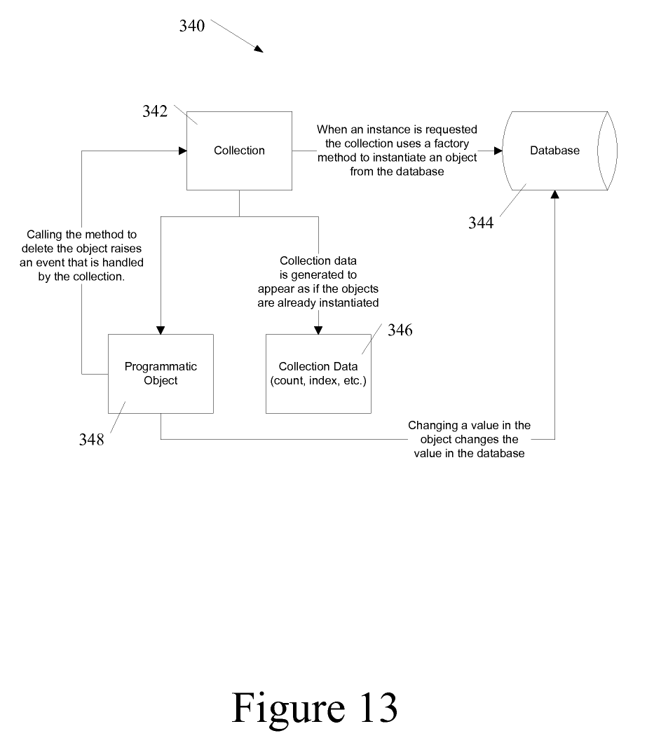

FIG. 14 illustrates a flow chart of a asset management platform, in accordance with one embodiment of the present invention;

FIG. 15 illustrates a flow chart of a asset management platform, in accordance with one embodiment of the present invention;

FIG. 16 illustrates a flow chart of a asset management platform, in accordance with one embodiment of the present invention;

FIG. 17 illustrates a flow chart of a asset management platform, in accordance with one embodiment of the present invention;

FIG. 18 illustrates a flow chart of a asset management platform, in accordance with one embodiment of the present invention; and

FIG. 19 illustrates a flow chart of a asset management platform, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

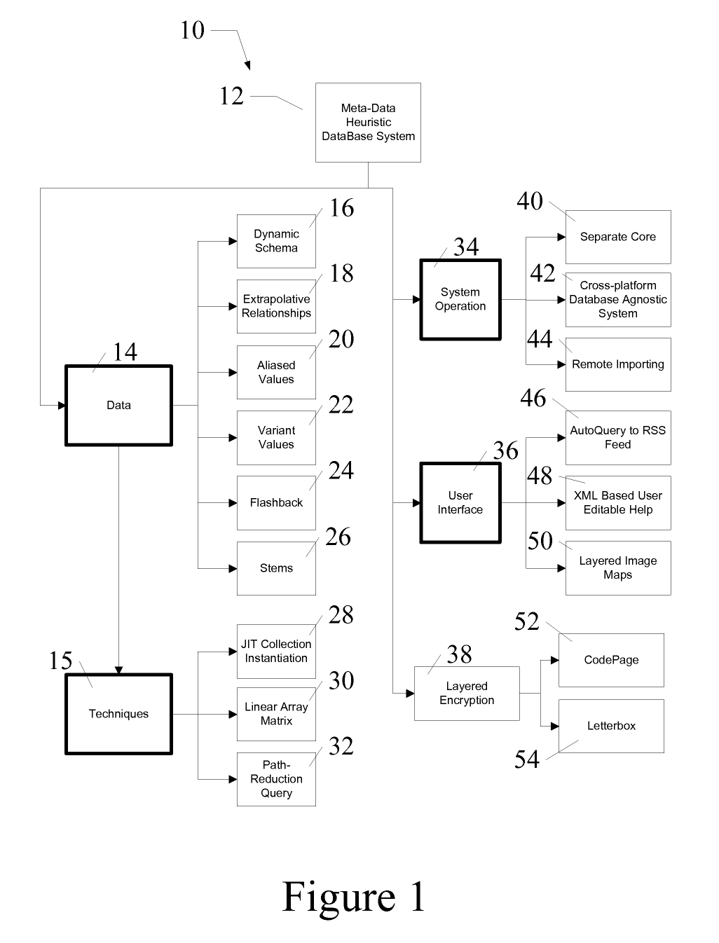

Referring now to FIG. 1, as in one embodiment illustrated is a flow chart of a database system 10. Shown is a Meta-Data Heuristic Data Base System 12 that is connected to data 14, system operation 34, user interface 36 and layered encryption 38. The data 14 connects to techniques 15 and dynamic schema 16, extrapolative relationships 18, aliased values 20, variant values 22, flashback 24 and stems 26. The techniques 15 connect to jit collection instantiation 28, linear array matrix 30 and path-reduction query 32. The system operation 34 connects to separate core 40, cross-platform database agnostic system 42 and remote importing 44. The user interface 36 connects to autoquery to rss feed 46, xml based user editable help 48 and layered image maps 50. The layered encryption 38 connects to codepage 52 and letterbox 54.

This database system 10 is a database that stores the schema, the database values, record constants, the “records” themselves, the value meta data, and the information of the definition of value types in a similar manner. While not specifically “Object-Oriented”, this system allows for greater flexibility of the data and it's schemas at run-time, without needing to redesign interfaces, running application code, or underlying schemas. Most database systems store the various information in separate processes, or do not store the information detailed above. This system could also vary the metadata and/or schema for each record in the database.

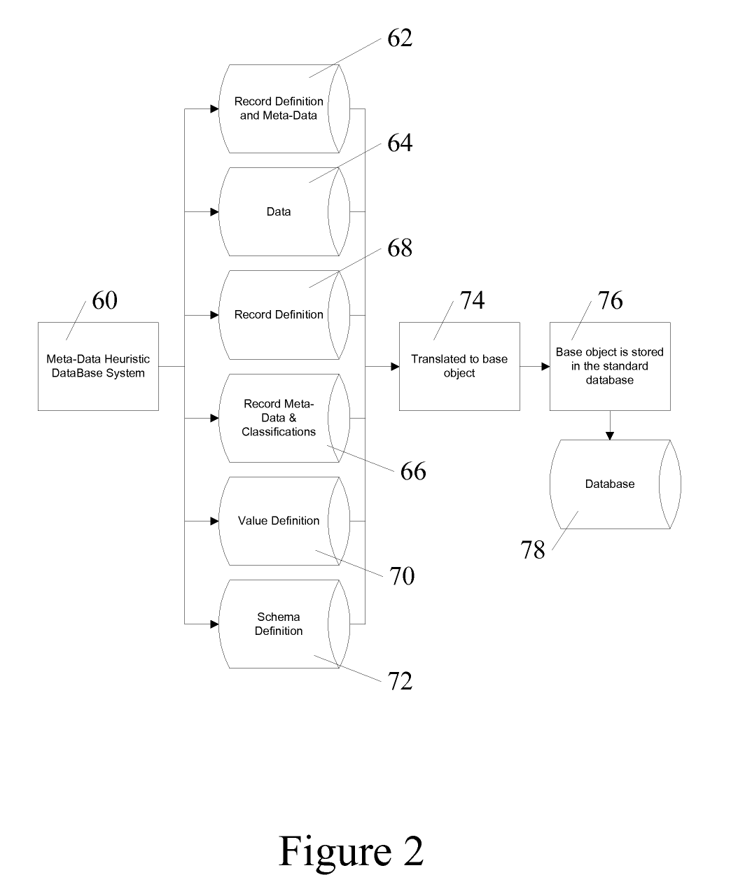

Referring to FIG. 2, as in one embodiment illustrated is a flow chart of a meta-data heuristic data base system 60. The meta-data heuristic data base system 60 is connected to a record definition and meta-data 62, data 64, record definition 66, record meta-data & classifications 68, value definition 70 and schema definition 72. The a record definition and meta-data 62, data 64, record definition 66, record meta-data & classifications 68, value definition 70 and schema definition 72 are all connect to a translated to base object 74. The base object 72 is then stored in the standard database 76. Shown is database 78.

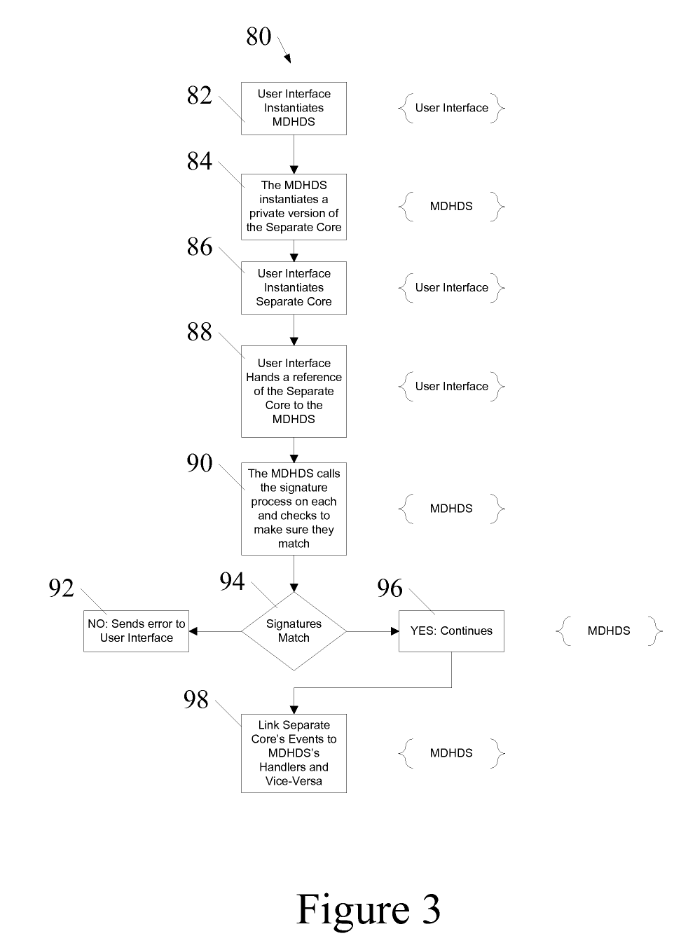

Referring to FIG. 3, as in one embodiment illustrated is a flow chart of a Separate Core handshake 80. Shown are User Interface Instantiates MDHDS 82 connected to The MDHDS instantiates a private version of the Separate Core 84 that connects to User Interface Instantiates Separate Core 86 User Interface Hands a reference of the Separate Core to the MDHDS 88 that connects to The MDHDS calls the signature process on each and checks to make sure they match 90. If a Signatures Match 94 is NO: Sends error to User Interface 92 if the Signatures Match 94 is YES: Continues 96 and Link Separate Core's Events to MDHDS's Handlers and Vice-Versa 98.

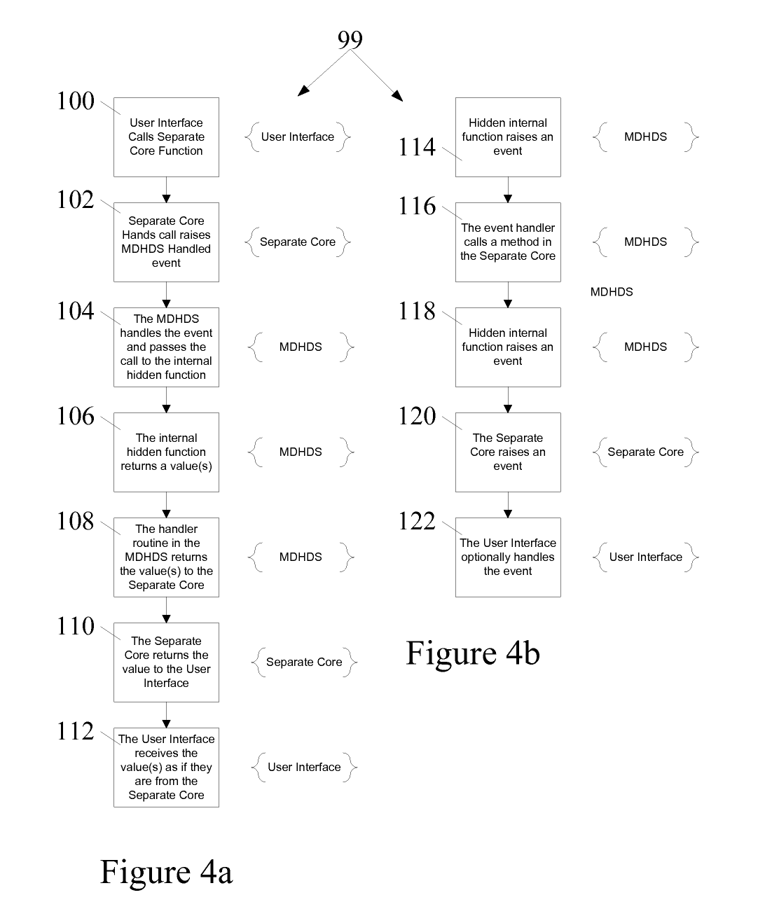

Referring to FIGS. 4a and 4b, as in one embodiment illustrated is a flow chart of a Separate Core relay 99. Shown is User Interface Calls Separate Core Function 100 that connects to Separate Core Hands call raises MDHDS Handled event 102 that connects to The MDHDS handles the event and passes the call to the internal hidden function 104 that connects to The internal hidden function returns a value(s) 106 that connects to The handler routine in the MDHDS returns the value(s) to the Separate Core 108 that connects to The Separate Core returns the value to the User Interface 110 that connects to The User Interface receives the value(s) as if they are from the Separate Core 112. Also shown is Hidden internal function raises an event 114 that connects to The event handler calls a method in the Separate Core 116 that connects to Hidden internal function raises an event 118 that connects to The Separate Core raises an event 120 that connects to The User Interface optionally handles the event 122.

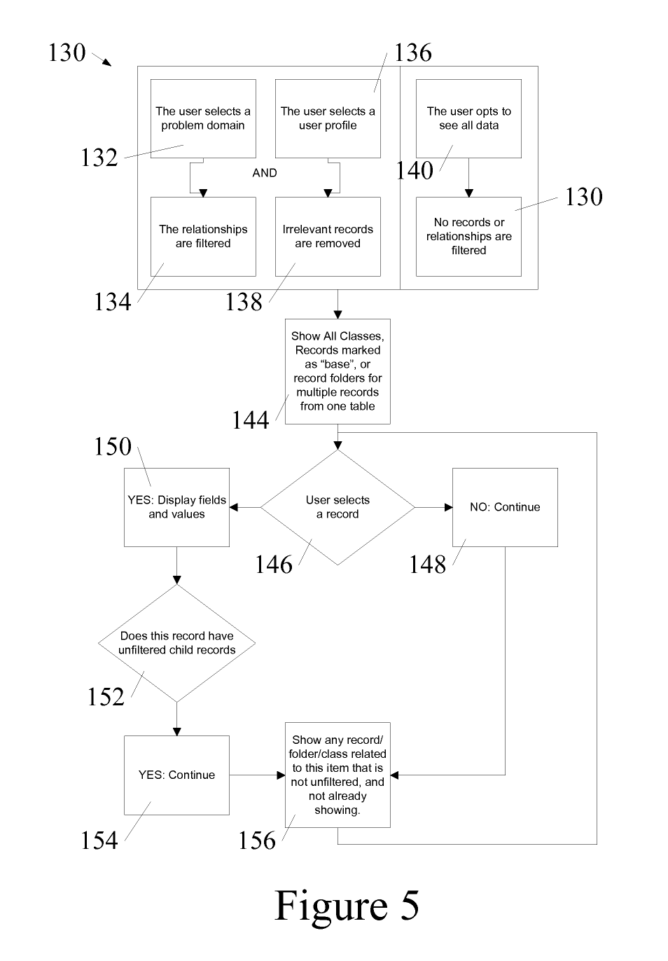

Referring to FIG. 5, as in one embodiment illustrated is a flow chart of a path reduction query 130. The user selects a problem domain 132 connects to The relationships are filtered 134. The user selects a user profile 136 connects to Irrelevant records are removed 138. The user opts to see all data 140 connects to No records or relationships are filtered 142. All of these connect to Show All Classes, Records marked as “base”, or record folders for multiple records from one table 144. A User selects a record 146. If NO continue 148. If YES Display Fields and Values 150. Does this record have unfiltered child records 152 if YES: Continue 154. Show any record/folder/class related to this item that is not unfiltered, and not already showing 156. Path-Reduction Query allows a user to generate a back-end query in real time, by selecting on objects, groups of objects, or classes of objects, and then showing those that are related as children to the object selected—while eliminating any object that was previously exposed up to the first object selected. This method of generating a query, specifically to find a single piece of data, takes place in real-time, allowing the user to modify their query as needed—and works in a more natural pattern then the current methods. Path-Reduction Query—this system allows a user to generate a back-end query in real time, by selecting on objects, groups of objects, or classes of objects, and then showing those that are related as children to the object selected—while eliminating any object that was previously exposed up to the first object selected. Benefits: This method of generating a query, specifically to find a single piece of data, takes place in real-time, allowing the user to modify their query as needed—and works in a more natural pattern then the current methods.

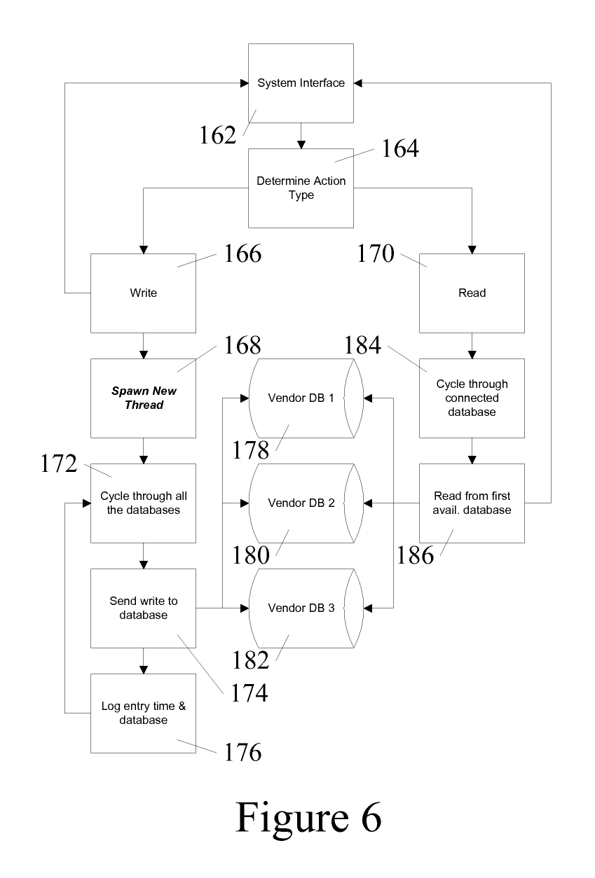

Referring to FIG. 6, as in one embodiment illustrated is a flow chart of a Cross-Platform Agnostic DB 160. Shown is System Interface 162, Determine Action Type 164, Write 166, Spawn New Thread 168, Read 170, Cycle through all the databases 172, Send write to database 174, Log entry time & database 176, Vendor DB 1 178, Vendor DB 2 180, Vendor DB 3 182, Cycle through connected database 184, Read from first avail. Database 186. The Cross-Platform Agnostic Database Access System off-loads database writes to a secondary system that can write database information to multiple separate and disparate databases. Among other things, this speeds performance of the system itself by moving the slower process of writing to the database to another system, and improves security by allowing multiple vendors to be used simultaneously. Cross-Platform Agnostic Database Access System—this system off-loads database writes to a secondary system that can write database information to multiple separate and disparate databases. Benefits: Among other things, this speeds performance of the system itself by moving the slower process of writing to the database to another system, and improves security by allowing multiple vendors to be used simultaneously.

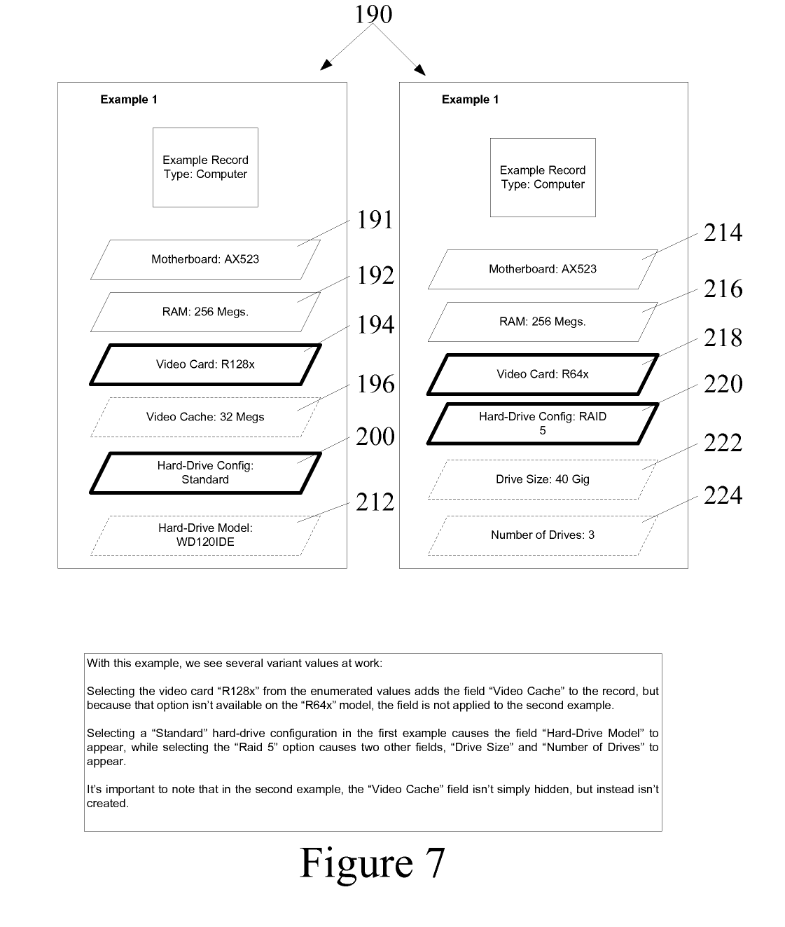

Referring to FIG. 7, as in one embodiment illustrated is a flow chart of variant values 190. Shown is Example 1: Motherboard AX523 191, RAM: 256 Megs 192, Video Card: R128x, 194, Video Cache: 32 Megs 196, Hard Drive Config: Standard 200, Hard-Drive Model: WD120IDE 212. Shown is Example 2: Motherboard AX523 214, RAM: 256 Megs 216, VideoCard: R64x 218, Hard-Drive Config: RAID 5 220, Drive Size: 40 Gig 222, Number of Drives: 3 224. With this example, we see several variant values at work: Selecting the video card “R128x” from the enumerated values adds the field “Video Cache” to the record, but because that option isn't available on the “R64x” model, the field is not applied to the second example. Selecting a “Standard” hard-drive configuration in the first example causes the field “Hard-Drive Model” to appear, while selecting the “Raid 5” option causes two other fields, “Drive Size” and “Number of Drives” to appear. It's important to note that in the second example, the “Video Cache” field isn't simply hidden, but instead isn't created. Variant Values—This system describes a value type in a database where additional fields for a given record appear based on the value entered in the base field. Example: If the value of the base field is less than 5, then fields X and Y become available, if the value is greater than 5 the fields A, B, and C become available—but not X and Y. Benefit: This allows a greater complexity of data to be stored without effecting the underlying program or schema.

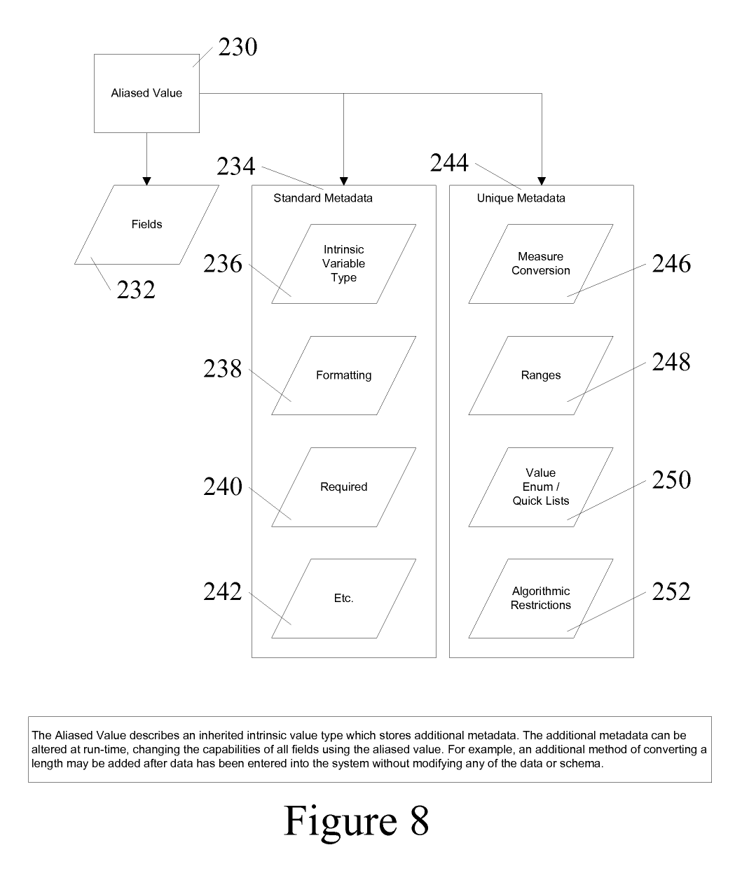

Referring to FIG. 8, as in one embodiment illustrated is a flow chart of aliased value 230. Shown is Fields 232. Also shown is Standard Metadata 234 with Intrinsic Variable Type 236 Formatting 238, Required, 240 and Etc. 242. Unique Metadata 244 Measure Conversion 246 is shown with Ranges 248, Value Enum/Quick Lists 250, Algorithmic Restrictions 252. The Aliased Value describes an inherited intrinsic value type which stores additional metadata. The additional metadata can be altered at run-time, changing the capabilities of all fields using the aliased value. For example, an additional method of converting a length may be added after data has been entered into the system without modifying any of the data or schema. Aliased Values—This system describes storing and retrieving database value types and related meta-data. The metadata is maintained concerning the value type and not actual data itself. This metadata may include

a. measurement conversion information
b. overlapping ranges of values that can be used to identify the status of values (such as “cold”, “warm”, and “hot”, where a value may be considered both warm AND hot)
c. User defined value enumerations, and “Quick List” or list of possible values which the user may append values to at run-time
Benefit: This system allows for data types to be created at run-time without modifying the underlying code. By storing this amount of meta-data about the value types, the system is able to adjust the data to specific user requirements.

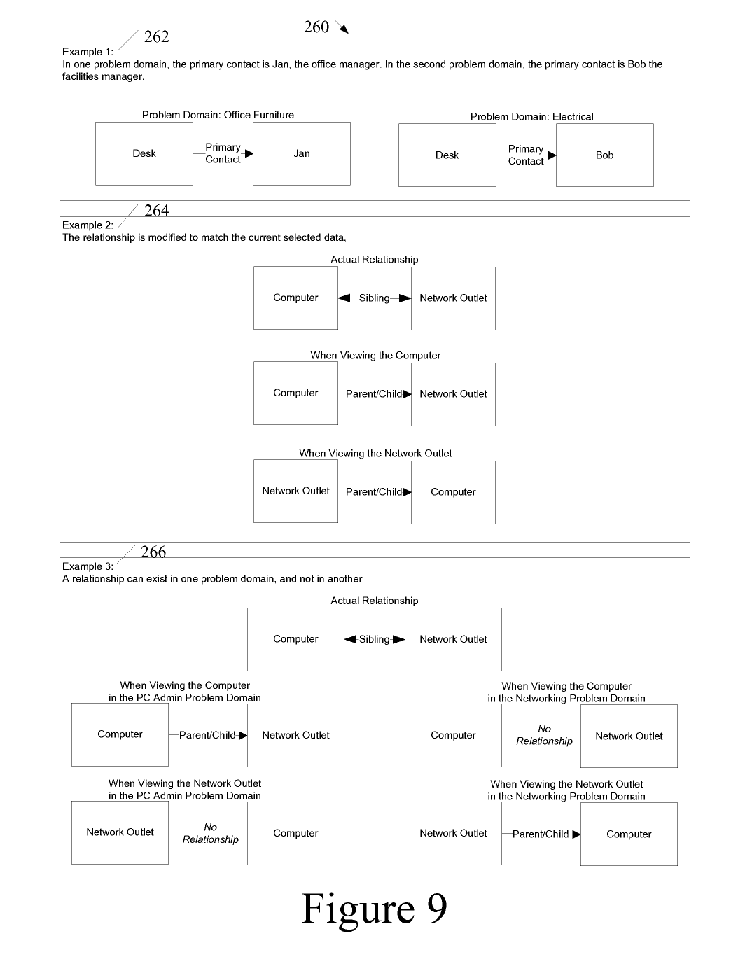

Referring to FIG. 9, as in one embodiment illustrated is a flow chart of Dynamic Schema 260. Shown is Example 1: 262 including Problem Domain: Office Furniture Desk>Primary Contact>Jan Problem Domain: Electrical Desk Primary Contact>Bob In one problem domain, the primary contact is Jan, the office manager. In the second problem domain, the primary contact is Bob the facilities manager. Also shown is Example 2: 264 Actual Relationship Computer>as sibling>Network Outlet When viewing the computer, Computer>parent/child>Network outlet When viewing the network outlet Computer>child/parent>Network outlet The relationship is modified to match the current selected data. Example 3: 266 Actual Relationship Computer>as sibling>Network Outlet When viewing the computer in the PC Admin problem domain Computer>parent/child>Network Outlet Network Outlet>no relationship>computer When viewing the computer in the networking problem domain Computer>no relationship>Network Outlet Network Outlet>parent/child>computer A relationship can exist in one problem domain, and not in another. Dynamic Schema—This system allows multiple relationships to be defined for a given set of data. These relationships can then be used to create a schema at run-time which may be modified by the user or outside process, based on the user or process's access permissions and problem domain. These relationships can be parent-child, sibling, or monistic—but using heuristic path reduction are extrapolated and displayed as parent-child based on the current record and previously examined records. Benefit: This allows for massive amounts of interrelated data to be consumable by humans, and allows for extremely intuitive application interfaces.

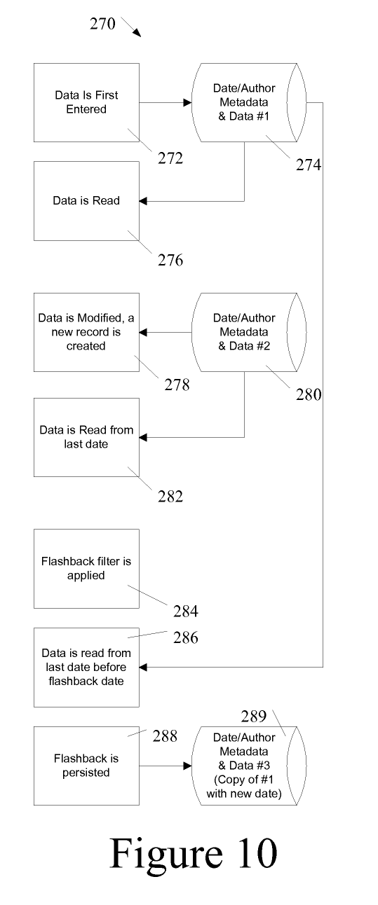

Referring to FIG. 10, as in one embodiment illustrated is a flow chart of Flashback 270. Shown is Data is first entered 272 with Date/Author Metadata & Data #1 274 then Data is read 276. Shown is Data is modified, a new record is created 278 Date/Author Metadata & Data #2 280 then Data is read from last date 282. A Flashback filter is applied 284. Data is read from last date before flashback date 286. A flashback is persisted 288 and Date/Author Metadata & Data #3 (Copy of #1 with new date) 289.

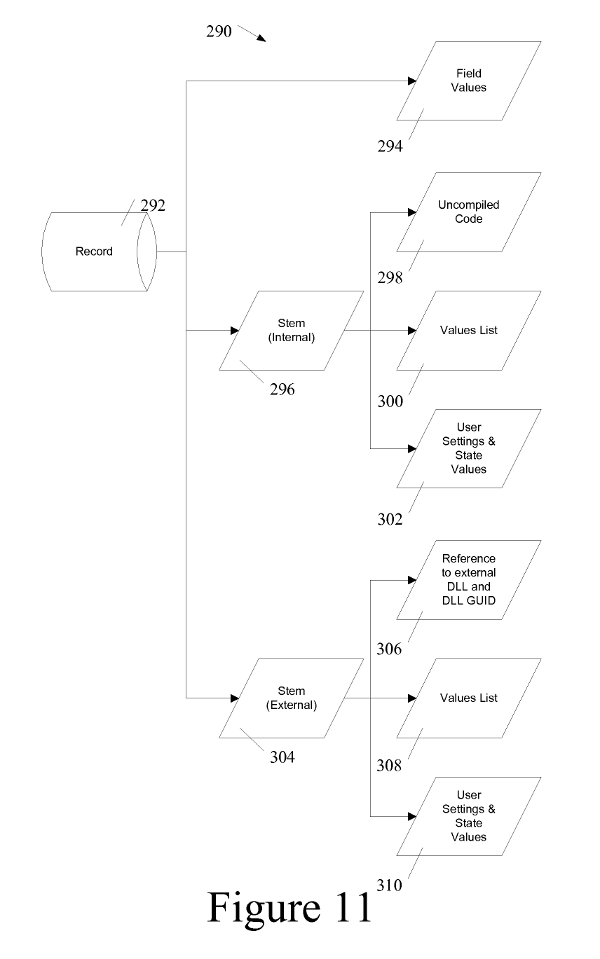

Referring to FIG. 11, as in one embodiment illustrated is a flow chart of stems 290. Shown is a Record 292 and Field Values 294. Stem (internal) 296 with Uncompliled Code 298, Values List 300 and User Settings & State Values 302. Shown is Stem (external) 304, Reference to external DLL and DLL GUID 306, Values List 308, User Settings & State Values 310. Stems—This system stores executable code (either compiled or uncompiled), a settings file, and the executed code's resultant values in the database. This can be either a full application, an “applet”, or application plug-in.

Example: A client wishes to maintain a “message board” for each of their products. The code for the message board and the actual messages themselves are stored in the record for each product. If a modification to the application is required for one of the products—say a special handicapped accessible feature—it can be applied without modifying the existing systems.
Benefits: This allows each record in the database to have a slightly modified executable set of instructions, which might be an algorithm or process. It also intrinsically ties the code base to a specific record or data.

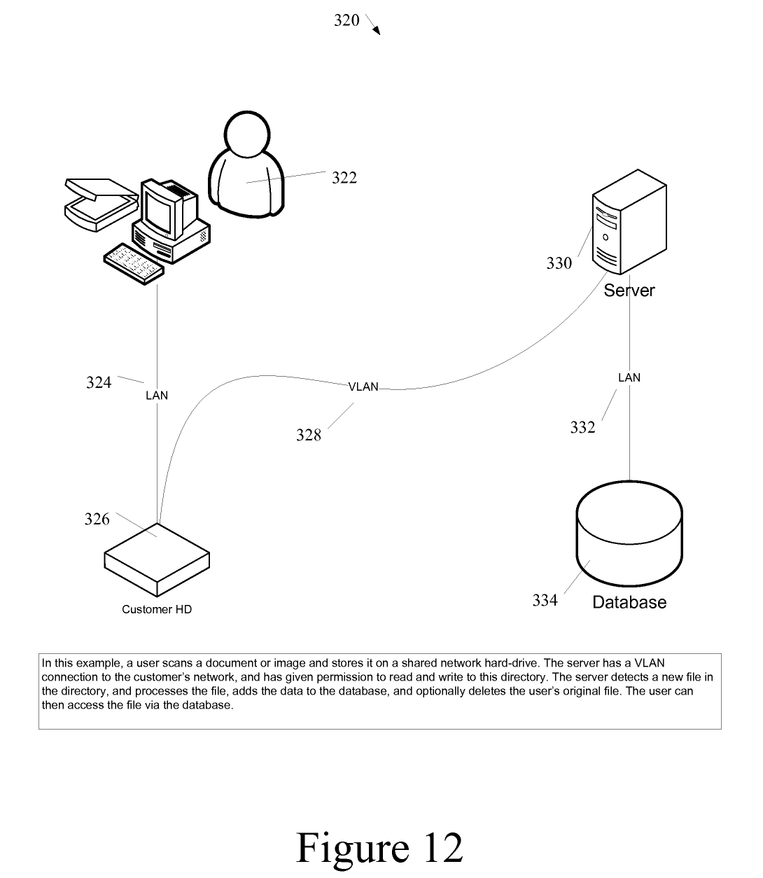

Referring to FIG. 12, as in one embodiment illustrated is a flow chart of Remote Importing 320. Shown is a User 322, LAN 324, Customer HD 326, VLAN 328, Server 330, LAN 332 and Database 334. In this example, a user scans a document or image and stores it on a shared network hard-drive. The server has a VLAN connection to the customer's network, and has given permission to read and write to this directory. The server detects a new file in the directory, and processes the file, adds the data to the database, and optionally deletes the user's original file. The user can then access the file via the database. Remote Importing—This process involves accessing a customer's system (specifically an assigned directory) via VPN, and compressing, encrypting, modifying, and/or importing the data into the database as they are created by the customer. Benefits: This system allows us to read reports generated by automated legacy systems or other such files, and automatically import the data into our systems.

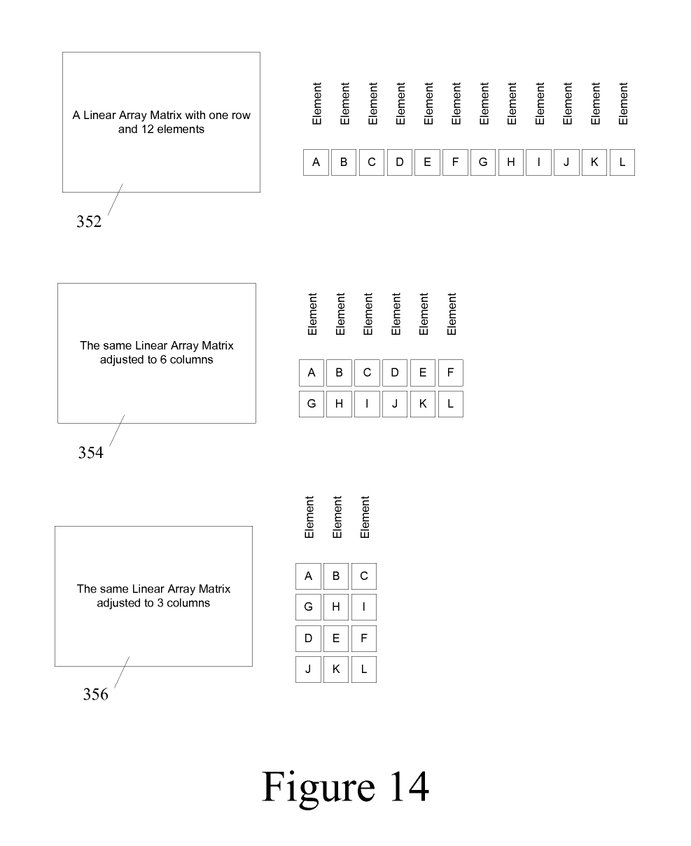

Referring to FIG. 14, as in one embodiment illustrated is a flow chart of Linear Array Matrix 350. Shown is A Linear Array Matrix with one row and 12 elements 352

ABCDEFGHIJKL

A Linear Array Matrix with two rows and 12 elements 354

ABCDEF

GHIJKL

A Linear Array Matrix with four rows and 12 elements 356

ABC

DEF

GHI

JKL

Linear Array Matrix—This process stores data in such a way that the parameters of an multidimensional array can be adjusted without moving the actual data.
Benefit: This allows for data to be entered from a stream without prior knowledge of the proper format of the data.

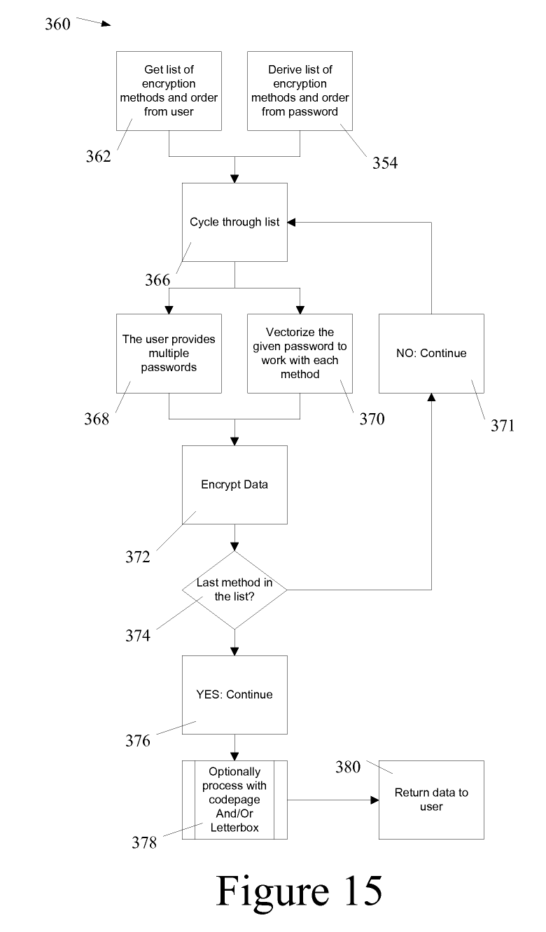

Referring to FIG. 15, as in one embodiment illustrated is a flow chart of Layered Encryption 360. Shown is Get list of encryption methods and order from user 362, Derive list of encryption methods and order from password 364, Cycle through list 366, User provides multiple passwords 368, Vectorize the given password to work with each method 370, This isn't the last method in the list YES then Encrypt data 372 NO then Continue 371, Is this the last method in the list 374, Yes, this is the last method in the list 376, Optionally process with codepage and/or letterbox 378, Return data to user 380. Layered Encryption—This process applies the output of one encryption method to the input of a second method. The encryption methods may be dissimilar, and may include “letterboxing” and “vectored summation” encryption methods described below. Benefit: By applying a layered encryption algorithm, a stream of data can be encrypted beyond the levels any of the existing encryption methods, and remove the weakness of any one method. “Codepage” Vectored Summation Encryption—This process encrypts data by summing a string of values—called a key—and the original data. If the key length is shorter than the original data, the string of values is then vectored—or altered by a known process such as adding an x value to all of the values in the original string of values, and appending these new values to the codepage to produce a larger key, where x is the position in the key equivalent to the vectoring increment. All summations, either from the original value, or extending the key, will be a modulus of a limiting number. Benefit: This algorithm, while technically weaker than most other encryption methods, offers the benefit of no limitations on the size of the encryption key, is quick to process, and can be used in conjunction with other techniques. Also, the algorithm intentionally does not check the validity of the key.

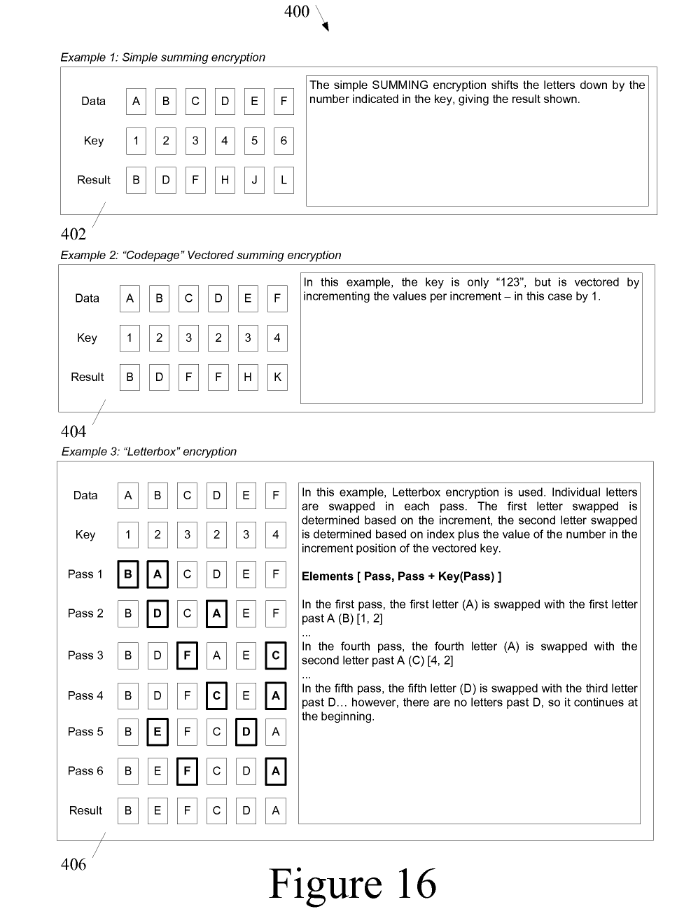

Referring to FIG. 16, as in one embodiment illustrated is a flow chart of Letterbox Encryption 400. Shown is Example 1: 402 Simple summing encryption

Data=ABCDEF

Key=123456

Result=BDFHJL

The simple SUMMING encryption shifts the letters down by the number indicated in the key, giving the result shown.

Example 2: 404 “Codepage” Vectored summing encryption

Data=ABCDEF

Key=123234

Result=BDFFHK

In this example, the key is only “123”, but is vectored by incrementing the values per increment—in this case by 1.

Example 3: 406 “Letterbox” encryption

Data=ABCDEF

Key=123234

Pass 1=BACDEF

Pass 2=BDCAEF

Pass 3=BDFAEC

Pass 4=BDFCEA

Pass 5=BEFCDA

Pass 6=BEFCDA

Result=BEFCDA

In this example, Letterbox encryption is used. Individual letters are swapped in each pass. The first letter swapped is determined based on the increment, the second letter swapped is determined based on index plus the value of the number in the increment position of the vectored key.

Elements [Pass, Pass+Key(Pass)]

In the first pass, the first letter (A) is swapped with the first letter past A (B) [1, 2]

In the fourth pass, the fourth letter (A) is swapped with the second letter past A (C) [4, 2]

In the fifth pass, the fifth letter (D) is swapped with the third letter past D . . . however, there are no letters past D, so it continues at the beginning. “Letterbox” bit-swapping encryption—This process describes a weak-encryption method that can be used with other, stronger encryption methods described in “Layered Encryption”. It encrypts a stream of data by swapping the Nxth byte with the Nyth byte, where x is an incremental value starting at the first bit, and y position is determined by x plus the incremental value in a vectored mask similar to the one described above. Benefit: Similar to the “Codepage” method described above, this method is fast to process, and can be used with additional encryption methodologies. This process essentially has similar limitations, and benefits of the “Codepage” method, but does not share its lineage.

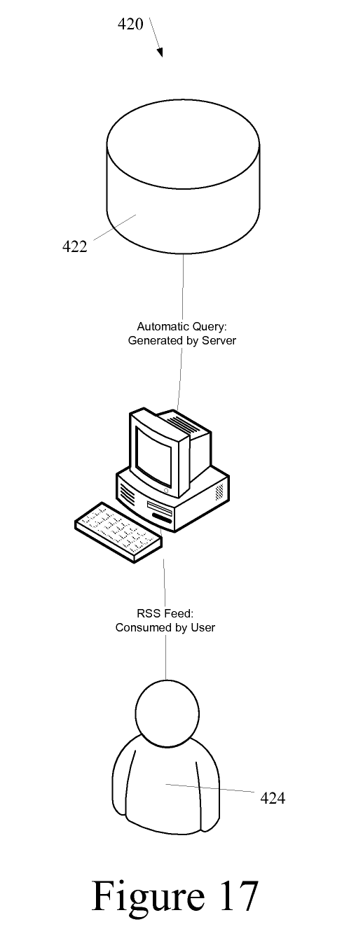

Referring to FIG. 17, as in one embodiment illustrated is a flow chart of RSS AutoQueries: 420. Shown is Data 422 Automatic Query: Generated by Server RSS Feed: Consumed by User and User 424. Using RSS feeds as targets for Automatic Queries—This process sends the result from an automated query to an RSS feed. Benefit: The end user can use an existing program, called an aggregator, to retrieve multiple RSS feeds—usually for news articles—to get information about the status of database activity, or other such data.

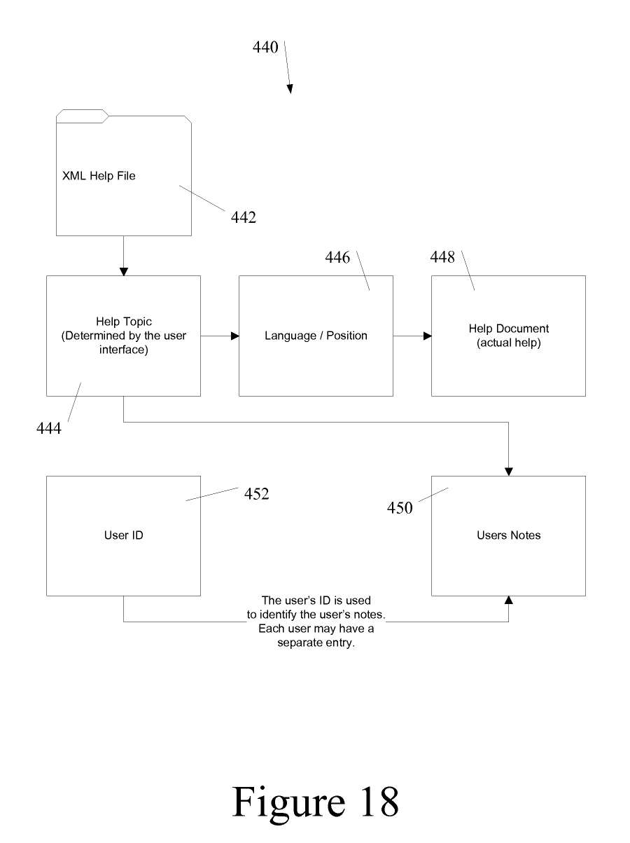

Referring to FIG. 18, as in one embodiment illustrated is a flow chart of Help System 440. Shown is XML Help File 442, Help Topic (Determined by the user interface) 444, Language/Position 446, Help Document (Actual Help) 448. Also shown is User Notes 450, User ID 452, The user's ID is used to identify the user's notes. Each user may have a separate entry. XML Based User editable Help System—This system displays a help system that includes a user editable section, and an area where actual help is displayed. The help text that is displayed can be varied by the user, i.e. Dependant on the language, skill level, or position of the user, different help text may be displayed. Benefit: The user can add comments or related notes directly in the help file without accidentally modifying the help text. The user may also adjust the help text itself based on his or her needs.

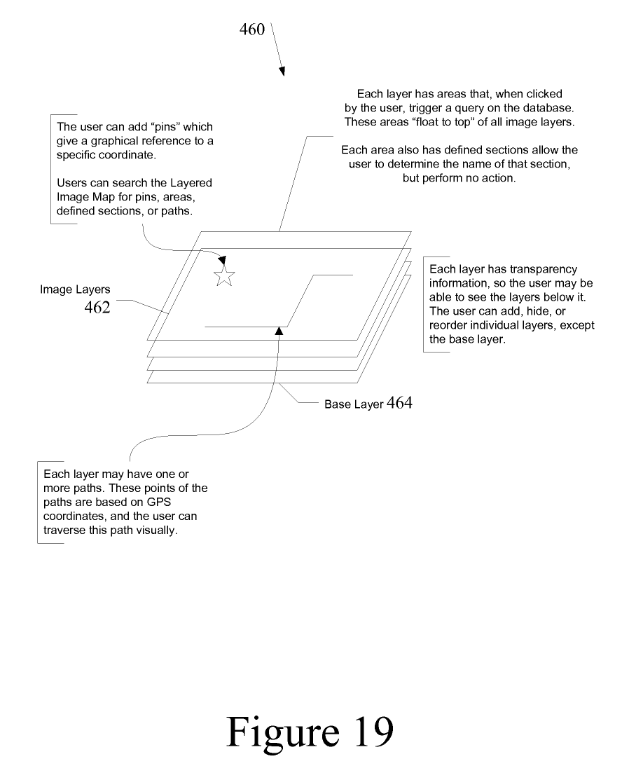

Referring to FIG. 19, as in one embodiment illustrated is a flow chart of Layered Image Maps 460. Shown is The user can add “pins” which give a graphical reference to a specific coordinate. Users can search the Layered Image Map for pins, areas, defined sections, or paths. Each layer has areas that, when clicked by the user, trigger a query on the database. These areas “float to top” of all image layers. Each area also has defined sections allow the user to determine the name of that section, but perform no action. Each layer has transparency information, so the user may be able to see the layers below it. The user can add, hide, or reorder individual layers, except the base layer. Each layer may have one or more paths. These points of the paths are based on GPS coordinates, and the user can traverse this path visually. Shown are Image Layers 462 and Base Layers 464. Layered Image Maps—This system used a series of layered images with transparencies and predefined areas that allow the user to select database records based on special relationships and/or location. The maps also may receive GPS data, to center the map on the physical location of the receiver. There is also a function to set points of a path, and move the map along those points. Benefit: The user is able to select records based on a physical location, diagram, or image—rather than based on a text-based query.

Meta-Data Heuristic Database System—this system is a database that stores the schema, the database values, record constants, the “records” themselves, the value meta data, and the information of the definition of value types in a similar manner.

Benefits: While not specifically “Object-Oriented”, this system allows for greater flexability of the data and it's schemas at run-time, without needing to redesign interfaces, running application code, or underlying schemas. Most database systems store the various information in separate processes, or do not store the information detailed above. This system could also vary the metadata and/or schema for each record in the database.
Separate Core UI—this system removes core “public” interface methods of the database system to a set of secondary methods contained in a separate DLL.
Benefits: If the user interface does not have a reference to the DLL, certain sensitive methods of the system are not only inaccessible, but invisible. This is especially important with newer languages that allow system reflection and make reverse-engineering simple.
Path-Reduction Query—this system allows a user to generate a back-end query in real time, by selecting on objects, groups of objects, or classes of objects, and then showing those that are related as children to the object selected—while eliminating any object that was previously exposed up to the first object selected.
Benefits: This method of generating a query, specifically to find a single piece of data, takes place in real-time, allowing the user to modify their query as needed—and works in a more natural pattern then the current methods
Cross-Platform Agnostic Database Access System—this system off-loads database writes to a secondary system that can write database information to multiple separate and disparate databases.
Benefits: Among other things, this speeds performance of the system itself by moving the slower process of writing to the database to another system, and improves security by allowing multiple vendors to be used simultaneously.
Aliased Values—This system describes storing and retrieving database value types and related meta-data. The metadata is maintained concerning the value type and not actual data itself. This metadata may include
a. measurement conversion information
b. overlapping ranges of values that can be used to identify the status of values (such as “cold”, “warm”, and “hot”, where a value may be considered both warm AND hot)
c. User defined value enumerations, and “Quick List” or list of possible values which the user may append values to at run-time
Benefit: This system allows for data types to be created at run-time without modifying the underlying code. By storing this amount of meta-data about the value types, the system is able to adjust the data to specific user requirements. This system describes a value type in a database where additional fields for a given record appear based on the value entered in the base field.
Example: If the value of the base field is less than 5, then fields X and Y become available, if the value is greater than 5 the fields A, B, and C become available—but not X and Y.
Benefit: This allows a greater complexity of data to be stored without effecting the underlying program or schema.
Dynamic Schema—This system allows multiple relationships to be defined for a given set of data. These relationships can then be used to create a schema at run-time which may be modified by the user or outside process, based on the user or process's access permissions and problem domain. These relationships can be parent-child, sibling, or monistic—but using heuristic path reduction are extrapolated and displayed as parent-child based on the current record and previously examined records.
Benefit: This allows for massive amounts of interrelated data to be consumable by humans, and allows for extremely intuitive application interfaces.
Extrapolative Relationships—This system allows relationships between records to be required or allowed based algorithmically.
Benefit: This allows a record stored in the database described above, to apply logic in determining which other records can or must be related to.
Example 1: A record of a patient taking a specific drug would be able to prevent or alert the data entry personnel when attempting to assign incompatible medications to a patient.
Example 2: A database designed to store components for a cubical manufacturer would be able to know if Panel A and Panel C are being used for an office layout, that Connector B is required.
Flashback—this process allows storing data in a database as it is edited separate from the original data or previous edits, along with a timestamp and user account information and location data. The system can use advanced filters to extrapolate how the information would be at a given previous time, if a specific account had never entered information, and/or a specific IP address had never entered information.
Benefits: It will be possible to “undo ad infinitum”, review the past status of the data, and will remove incorrect entries from a malicious or incompetent user.
Stems—This system stores executable code (either compiled or uncompiled), a settings file, and the executed code's resultant values in the database. This can be either a full application, an “applet”, or application plug-in.
Example: A client wishes to maintain a “message board” for each of their products. The code for the message board and the actual messages themselves are stored in the record for each product. If a modification to the application is required for one of the products—say a special handicapped accessible feature—it can be applied without modifying the existing systems.
Benefits: This allows each record in the database to have a slightly modified executable set of instructions, which might be an algorithm or process. It also intrinsically ties the code base to a specific record or data.
Remote Importing—This process involves accessing a customer's system (specifically an assigned directory) via VPN, and compressing, encrypting, modifying, and/or importing the data into the database as they are created by the customer.
Benefits: This system allows us to read reports generated by automated legacy systems or other such files, and automatically import the data into our systems.
Just-In-Time Collection Instantiation—This process instantiates computer “objects” as they are called from a collection only when a specific instance is required, and retrieves the properties for that object from a database, while maintaining the appearance to the system as if all items in the collection have been instantiated. The collection appears to contain all of the objects at all times, however, only one object is actually instantiated at any given time.
Benefit: This process allows the user to operate on a much larger amount of data without requiring the equivalent system resources or network bandwidth, as only one object exists per collection at any given time.
Linear Array Matrix—This process stores data in such a way that the parameters of an multidimensional array can be adjusted without moving the actual data.
Benefit: This allows for data to be entered from a stream without prior knowledge of the proper format of the data
Layered Encryption—This process applies the output of one encryption method to the input of a second method. The encryption methods may be dissimilar, and may include “letterboxing” and “vectored summation” encryption methods described below.
Benefit: By applying a layered encryption algorithm, a stream of data can be encrypted beyond the levels any of the existing encryption methods, and remove the weakness of any one method.
“Codepage” Vectored Summation Encryption—This process encrypts data by summing a string of values—called a key—and the original data. If the key length is shorter than the original data, the string of values is then vectored—or altered by a known process such as adding an x value to all of the values in the original string of values, and appending these new values to the codepage to produce a larger key, where x is the position in the key equivalent to the vectoring increment. All summations, either from the original value, or extending the key, will be a modulus of a limiting number.
Benefit: This algorithm, while technically weaker than most other encryption methods, offers the benefit of no limitations on the size of the encryption key, is quick to process, and can be used in conjunction with other techniques. Also, the algorithm intentionally does not check the validity of the key.
“Letterbox” bit-swapping encryption—This process describes a weak-encryption method that can be used with other, stronger encryption methods described in “Layered Encryption”. It encrypts a stream of data by swapping the Nxth byte with the Nyth byte, where x is an incremental value starting at the first bit, and y position is determined by x plus the incremental value in a vectored mask similar to the one described above.
Benefit: Similar to the “Codepage” method described above, this method is fast to process, and can be used with additional encryption methodologies. This process essentially has similar limitations, and benefits of the “Codepage” method, but does not share its lineage.
Using RSS feeds as targets for Automatic Queries—This process sends the result from an automated query to an RSS feed
Benefit: The end user can use an existing program, called an aggregator, to retrieve multiple RSS feeds—usually for news articles—to get information about the status of database activity, or other such data.
XML Based User editable Help System—This system displays a help system that includes a user editable section, and an area where actual help is displayed. The help text that is displayed can be varied by the user, i.e. Dependant on the language, skill level, or position of the user, different help text may be displayed.
Benefit: The user can add comments or related notes directly in the help file without accidentally modifying the help text. The user may also adjust the help text itself based on his or her needs.
Layered Image Maps—This system used a series of layered images with transparencies and predefined areas that allow the user to select database records based on special relationships and/or location. The maps also may receive GPS data, to center the map on the physical location of the receiver. There is also a function to set points of a path, and move the map along those points.
Benefit: The user is able to select records based on a physical location, diagram, or image—rather than based on a text-based query.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A database system for storing a schema, values, record constants, value metadata, and records, the database component comprising:
a. a storage component for storing a plurality of records;
b. a dynamic schema component comprising value types and relationships for describing what records contain;
c. a query engine component for retrieving records and meta-data from the system;
d. a user interface component, further comprising a separate core interface component for removing public interface methods of the database system to a set of secondary methods contained in a separate component, for allowing the user to interact with the system;
e. a help system component for informing the user how to use the system; and
f. a remote importing component for accessing remote systems.

2. The database system of claim 1 wherein the dynamic schema component can create the schema at runtime.

3. The database system of claim 1 wherein the storage component offloads writing of records to a secondary database system.

4. The database system of claim 1 wherein the query engine allows for selecting an object and displaying the objects that are related to it while eliminating any object previously exposed up to the first object selected.

5. The database system of claim 1 wherein the value types of the dynamic schema component allow overlapping ranges of values, measurement conversion information, and user defined value enumerations.

6. The database system of claim 1 wherein the value types of the dynamic schema component allows additional fields in records to exist based on the value stored in a record with a relationship to the current record.

7. The database system of claim 1 wherein the dynamic schema component allows the user to define parent-child, sibling, and monistic relationships for the records.

8. The database system of claim 1 wherein the dynamic schema component allows relationships between records to be defined as required or allowed based on a separate algorithm.

9. The database system of claim 1 wherein the storage component stores records in an encrypted form.

10. The database system of claim 1 wherein the query engine component outputs query in RSS format.

11. The database system of claim 1 wherein the storage component further comprises a linear array matrix so that the parameters of an multidimensional array can be adjusted without moving the actual data.

12. The database system of claim 1 wherein the query engine component allows the user to select records based on physical location, diagrams, and images.

13. The database system of claim 1 wherein the help system component further comprises a user editable text section.

14. The database system of claim 1 wherein the query engine component instantiates collections objects on-demand.

15. The database system of claim 1 wherein the storage component allows storing edited data separate from the original data and previous edits.

16. The database system of claim 1 wherein the remote importing component allows compressing, encrypting, and importing data from the remote system.

17. The database system of claim 1 wherein the storage component allows storing executable code.

18. A database system comprising:
data manipulated with techniques; and
system operation, user interface and layered encryption.
